(19) United States
(12) Patent Application Publication
(10) Pub. No.: US 2006/0221277 A1
(43) Pub. Date: Oct. 5, 2006

(54) Transreflective liquid crystal display

(75) Inventors: Young-Chol Yang, Gyeonggi-do (KR); Jeong--Ye Choi, Gyeonggi-do (KR); Jae-Hyuk Chang, Seoul (KR); Mun-Pyo Hong, Gyeonggi-do (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/393,038

(22) Filed: Mar. 30, 2006

(30) Foreign Application Priority Data
Mar. 30, 2005 (KR) 10-2005-0026531

(51) Int. Cl. G02F 1/1335

(52) U.S. Cl. 349/114

(57) ABSTRACT

A transreflective LCD includes a plurality of pixels arranged in a matrix, each including a switching element, a backlight for supplying light to the pixels, and first, second, third, and fourth capacitors which are individually connected to output terminals of the switching elements. Each pixel includes a transmissive area for transmitting light from the backlight, and a first reflective area and a second reflective area for reflecting light originating from the exterior environment. In this way, the reflective area is divided into two areas and the auxiliary capacitor is provided in one area of the two. The gamma curves of the transmissive mode and the reflective mode can meet together at a curve by controlling the dimension ratio and the voltage ratio of the two areas. In this way, color display showing uniform color sense can be realized without regard to changes in mode.

### CROSS-REFERENCE TO RELATED APPLICATIONS

This application claims the benefit of Korean Patent Application No. 2005-0026531, filed on Mar. 30, 2005, in the Korean Intellectual Property Office, the disclosure of which is incorporated herein by reference.

### BACKGROUND OF THE INVENTION

(a) Field of the Invention

The present invention relates generally to liquid crystal displays, and more particularly, to transreflective liquid crystal displays.

(b) Description of the Related Art

Recently, liquid crystal displays (LCDs) have been the most widely used among flat panel display devices. Generally, an LCD includes a pair of panels with field generating electrodes on their inner surfaces, and a dielectric anisotropy liquid crystal layer interposed between the panels. In the LCD, a variation in the voltage difference between field generating electrodes, i.e., a variation in strength of an electric field generated by the electrodes, changes the transmittance of the liquid crystal layer. In this manner, desired images are obtained by controlling the voltage difference between the electrodes.

Depending on the kinds of light sources used for image display, the LCDs are divided into three types: transmissive, reflective, and transreflective LCDs. In the transmissive LCDs, the pixels are illuminated from behind using a backlight. In the reflective LCDs, the pixels are illuminated from the front using incident light originating from the ambient environment. The transreflective LCDs combine transmissive and reflective characteristics. Under medium light conditions such as in an indoor environment or under complete darkness conditions, these LCDs are operated in the transmissive mode, while under very bright conditions such as in an outdoor environment, they are operated in the reflective mode.

In many transreflective LCDs, each pixel is divided into a transmissive area and a reflective area. These LCDs can selectively operate in the transmissive mode or in the reflective mode. However, they have a drawback, in that gamma curves of the two modes conflict due to differences in optical retardation with respect to the liquid crystal. This is because light passes through the liquid crystal layer only once in the transmissive mode, but twice in the reflective mode.

There are currently two ways to overcome this drawback. One is to form the liquid crystal layer more thinly in the reflective areas than in the transmissive areas. The other is to differentiate alignment of the liquid crystal layer existing in the two areas by providing a voltage in the reflective areas that is lower than that applied to the transmissive areas.

The former has some drawbacks. The manufacturing process becomes complex since a process to form a thick layer in the reflective area is added. Also, problematic alignment of the liquid crystal layer such as declination, and/or incidental images may occur due to a large step difference at the borders of the two areas.

In the latter, an auxiliary capacitor is typically provided in the reflective area to lower the voltage applied to the pixel. However, this leads to a difference in the gamma curves of the two modes. Accordingly, images in the two modes are shown differently.

Accordingly, continuing efforts exist to develop transreflective LCDs with improved indoor and outdoor viewing characteristics.

### SUMMARY OF THE INVENTION

An objective of the present invention is to provide an LCD capable solving the above-mentioned problems.

To achieve the objective, according to an aspect of the present invention, there is provided an LCD comprising: a plurality of pixels arranged in a matrix, each including a switching element; a backlight for supplying light to the pixels; and first, second, third, and fourth capacitors which are individually connected to output terminals of the switching elements. Here, each pixel includes a first area for transmitting light supplied by the backlight, and a second area and a third area for reflecting light.

The first capacitor may be located within the first area, the second capacitor may be located within the second area, and the third and fourth capacitors may be located within the third area. The third and fourth capacitors may also have differing permittivities and be connected to each other in series.

A voltage between both ends of the second capacitor may be equal to those of the third and fourth capacitors, and that a voltage across the third capacitor is lowered by capacitance of the third and fourth capacitors.

The LCD may be configured to satisfy:
Rt=R2+R3=(1−s)V+skV

where Rt is a total reflectance of the second area and the third area, R2 is a reflectance of the second area, R3 is a reflectance of the third area, s is a dimension ratio of an area of the third area to the total area of the second area and the third area, V is a voltage applied to the second capacitor, and k is a voltage ratio of a voltage applied to the third capacitor with respect to a sum of a voltage applied to the third capacitor and a voltage applied to the fourth capacitor.

The voltage ratio k may also be determined according to:
k=C4/(C3+C4)

where C3 is a capacitance of the third capacitor, and C4 is a capacitance of the fourth capacitor.

The voltage ratio of a voltage applied to the second capacitor to a voltage applied to the third capacitor may be in a range from about 1:0.6 to about 1:0.9, and the dimension ratio of an area of the second area to an area of the third area is in a range from about 0.3:0.7 to about 0.5:0.5.

According to another aspect of the present invention, there is provided an LCD comprising: an upper panel and a lower panel facing each other; and a liquid crystal layer interposed between the two panels. The upper panel includes: an insulating substrate; a shading means formed on the insulating substrate; a plurality of color filters formed on the shading means and the insulating substrate; a first overcoat layer and a second overcoat layer that are separated from each other on the color filters; a common electrode formed on the first and second overcoat layer and the color filters; and a third overcoat layer formed on the common electrode, while being separated from the first and second overcoat layers.

In addition, the upper panel may include a first area for transmitting light within the liquid crystal display, and a second area and a third area for reflecting light outside the liquid crystal display.

The first and second areas may include the first overcoat layer and the second overcoat layer respectively, and the third area may include the third overcoat layer. The third overcoat layer may be formed only in the third area.

Alternately, the first and second areas may include the first overcoat layer and the second overcoat layer respectively, and the third area may include a third overcoat layer. The third overcoat layer may be formed throughout the first, second, and third areas.

In addition, the lower panel may include pixel electrodes to which data voltages are applied, and the first, second, and third areas may include first, second, and third capacitors, respectively. In this case, it is preferable that each capacitor includes the pixel electrode and the common electrode as two terminals, and that the liquid crystal layer functions as a dielectric of the same capacitor. It is also preferable that the third area further includes a fourth capacitor having the pixel electrode and the common electrode as two terminals, and that the third overcoat layer functions as a dielectric of the fourth capacitor.

The LCD may be configured to satisfy the equation:
Rt=R2+R3=(1−s)V+skV

where Rt is a total reflectance of the second and third areas, R2 is a reflectance of the second area, R3 is a reflectance of the third area, s is a dimension ratio of an area of the third area to a total area of the second area and third area, V is a voltage applied to the second capacitor, and k is a voltage ratio of a voltage applied to the third capacitor to a sum of the voltage applied to the third capacitor and the voltage applied to the fourth capacitor.

The voltage ratio k may also be determined by:
k=C4/(C3+C4)

where C3 is a capacitance of the third capacitor, and C4 is a capacitance of the fourth capacitor.

The voltage ratio may be in a range from about 0.6 to about 0.9, and the dimension ratio may be in a range from about 1 to about 2⅓.

The first, second, and third overcoat layers may comprise transparent insulating materials.

The overcoat layer has a thickness determined by the voltage ratio.

Also, the pixel electrode formed in the second and third areas can include an uneven pattern.

The LCD is operated in a transmissive mode and in a reflective mode, and the liquid crystal display is configured to operate in a transmissive mode and in a reflective mode, and wherein a threshold voltage of the liquid crystal layer in the transmissive mode is substantially equal to a threshold voltage of the liquid crystal layer in the reflective mode.

### BRIEF DESCRIPTION OF THE DRAWINGS

The above objects and other advantages of the present invention will become more apparent by describing the preferred embodiments thereof in more detail with reference to the accompanying drawings.

FIG. 1 is a block diagram of an LCD according to an embodiment of the present invention.

FIG. 2 is an equivalent circuit view of a pixel of an LCD according to an embodiment of the present invention.

FIG. 3 is a layout view of an LCD according to an embodiment of the present invention.

FIG. 4 is a cross-sectional view cut along IV-IV′ of FIG. 3.

FIG. 5 is a cross-sectional view cut along V-V′ of FIG. 3.

FIG. 6 is a cross-sectional view cut along VI-VI′ of FIG. 3.

FIG. 7 is an equivalent circuit view of a pixel of an LCD according to another

FIG. 8 is a graph for showing results of simulation for transmittance and reflectance of an LCD according to an embodiment of the present invention.

FIG. 9 is a graph for showing actually measured transmittance and reflectance from an LCD according to an embodiment of the present invention.

FIG. 10 is a schematic cross-sectional view of a pixel employed in an LCD according to an embodiment of the present invention.

### DETAILED DESCRIPTION OF THE PREFERRED EMBODIMENTS

Preferred embodiments of the present invention will be described more fully hereinafter with reference to the accompanying drawings, in which preferred embodiments of the invention are shown. The present invention may, however, be embodied in different forms and should not be construed as being limited to the embodiments set forth herein. Rather, these embodiments are provided so that this disclosure will be thorough and complete, and will fully convey the scope of the invention to those skilled in the art.

In the drawings, the thickness of the layers, films, and regions are exaggerated for clarity. Like numerals refer to like elements throughout. It will be understood that when an element such as a layer, film, region, or substrate is referred to as being “on” another element, it can be directly on the other element or intervening elements may also be present. Also, it is to be understood that the drawings are diagrammatic and not necessarily to scale.

Hereinafter, an LCD according to a preferred embodiment of the present invention will be described in detail with reference to the accompanying drawings.

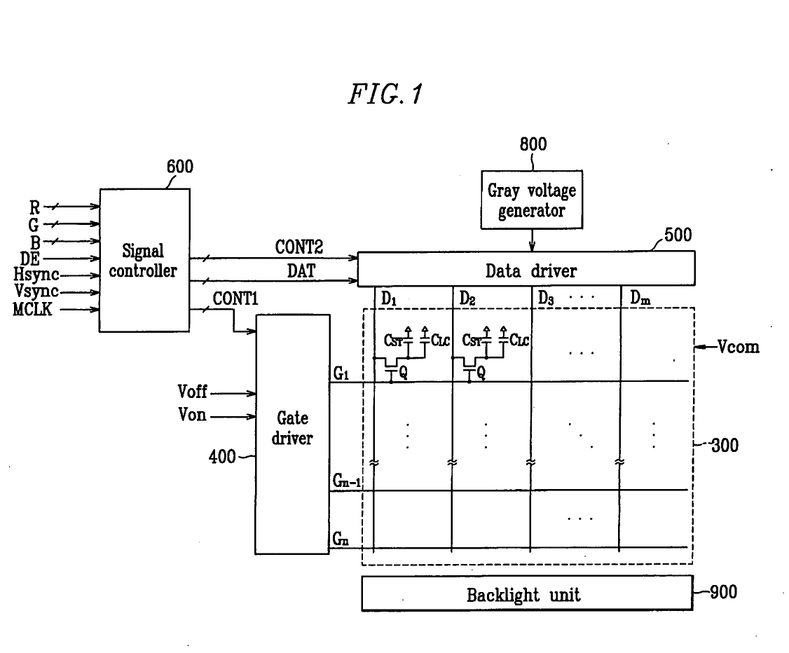

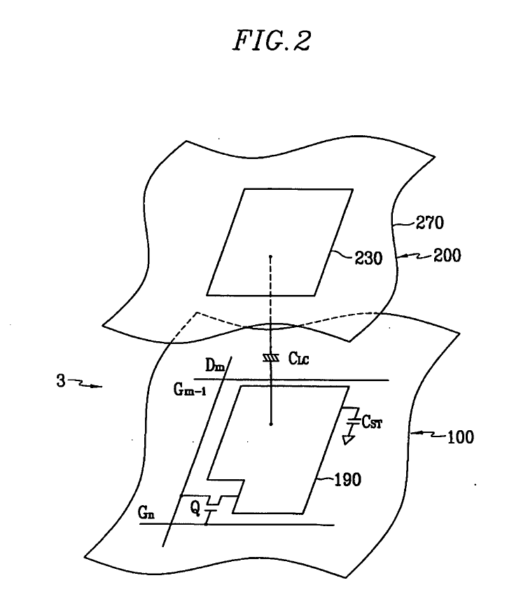

FIG. 1 is a block diagram of an LCD according to an embodiment of the present invention, and FIG. 2 is an equivalent circuit view of a pixel of an LCD according to an embodiment of the present invention.

Referring to FIG. 1, an LCD according to an embodiment of the present invention comprises an LC panel assembly 300, a gate driver 400 and a data driver 500 that are connected to the LC panel assembly 300, a gray voltage generator 800 connected to the data driver 500, a backlight unit 900 for supplying light to the LC panel assembly 300, and a signal controller 600 for controlling the above elements.

Referring to FIG. 1, the LC panel assembly 300 includes a plurality of display signal lines G₁-Gₙ and D₁-Dₘ, and a plurality of pixels connected thereto and arranged substantially in a matrix.

The display signal lines G₁-Gₙ and D₁-Dₘ include a plurality of gate lines G₁-Gₙ for transmitting gate signals (also referred to as “scanning signals”), and a plurality of data lines D₁-Dₘ for transmitting data signals. The gate lines G₁-Gₙ extend substantially in a row direction and are substantially parallel to each other, while the data lines D₁-Dₘ extend substantially in a column direction and are substantially parallel to each other.

Each pixel includes a switching element Q that is connected to the display signal lines G₁-Gₙ and D₁-Dₘ, as well as an LC capacitor C_{LC} and a storage capacitor C_{ST} that are both connected to the switching element Q. The storage capacitor C_{ST} may be omitted.

Referring to FIGS. 1 and 2, the switching element Q is provided on the lower panel 100 and has three terminals: a control terminal connected to one of the gate lines G₁-Gₙ; an input terminal connected to one of the data lines D₁-Dₘ; and an output terminal connected to both the LC capacitor C_{LC} and the storage capacitor C_{ST}. The switching element Q may be a thin film transistor (TFT) and includes amorphous silicon. The LC capacitor C_{LC} includes a pixel electrode 190 provided on the lower panel 100, and a common electrode 270 provided on the upper panel 200, as two terminals. The LC layer 3 interposed between the two electrodes 190 and 270 functions as the dielectric of the LC capacitor C_{LC}. The pixel electrode 190 is connected to the switching element Q, and the common electrode 270 is supplied with a common voltage V_{com} and covers the entire surface of the upper panel 200. In embodiments that differ from FIG. 2 but that are still within the scope of the invention, the common electrode 270 may be provided on the lower panel 100. In this case, both the pixel electrode 190 and the common electrode 270 can be generally shaped as a bar or a stripe.

When the pixel electrode 190 and a separate signal line (not shown), which is provided on the lower panel 100, are overlapped with each other, the overlap portion becomes the storage capacitor C_{ST}. The separate signal line is supplied with a predetermined voltage such as the common voltage V_{com}. Alternately, the storage capacitor C_{ST} may be formed by overlapping the pixel electrode 190 with a previous gate line that is placed directly above the pixel electrode 190, and interposing an insulator therebetween.

The backlight unit 900 includes an inverter (not shown) and a light source (not shown). The light source is mounted under the LC panel assembly 300 with at least one lamp. Cold cathode fluorescent lamps (CCFLs) or external electrode fluorescent lamps (EEFLs) are commonly used as lamps, but light emitting diodes (LEDs) may also be used.

For color display, each pixel typically exhibits one color. Accordingly, red, green, and blue color filters 230 are each provided at regions of the upper panel 200 facing the pixel electrodes 190.

Referring to FIG. 2, the color filters 230 are formed at corresponding regions of the upper panel 200. Alternately, they may be formed on or under the pixel electrodes 190 of the lower panel 100.

At least one polarizer (not shown) is provided on either outer surface of the two panels 100 and 200 for polarizing light emitted from the light source.

The gray voltage generator 800 generates two sets of a plurality of gray voltages related to the transmittance of the pixels. The gray voltages in one set have positive polarity with respect to the common voltage v_{com}, while those of the other set have negative polarity with respect to the common voltage V_{com}.

The gate drivers 400 are individually connected to the gate lines G₁-Gₙ of the LC panel assembly 300 for transmitting the gate signals consisting of combinations of the gate-on voltage Vₒₙ and the gate-off voltage V_{off} input from an external device to the gate signal lines G₁-Gₙ. These gate drivers 400 are shift registers with a plurality of stages arranged substantially in a line.

The data drivers 500 are individually connected to the data lines D₁-Dₘ of the LC panel assembly 300 for transmitting the data voltages, which are selected from the gray voltages supplied from the gray voltage generator 800, to the pixels. These data drivers 500 are commonly formed as integrated circuits.

The signal controller 600 controls the operation of the gate drivers 400 or the data drivers 500.

Hereinafter, the operation of the above-mentioned LCD will be described in more detail.

The signal controller 600 receives input image signals R, G, and B and input control signals for controlling the display thereof such as a vertical synchronizing signal V_{sync}, a horizontal synchronizing signal H_{sync}, a main clock signal MCLK, a data enable signal DE, etc., from an external graphic controller (not shown). In response to the input control signals, the signal controller 600 generates gate control signals CONT1 and data control signals CONT2, and processes the image signals R, G, and B suitably for the operation of the LC panel assembly 300. Then, the signal controller 600 outputs the gate control signals CONT1 to the gate driver 400, while outputting the data control signals CONT2 and the processed image signals DAT to the data driver 500.

The gate control signals CONT1 include a vertical synchronizing start signal STV for informing the beginning of output of a gate-on voltage Vₒₙ, a gate clock signal CPV for controlling the output time of the gate-on voltage Vₒₙ, and an output enable signal OE for defining the duration of the gate-on voltage Vₒₙ.

The data control signals CONT2 include a horizontal synchronizing start signal STH for informing the beginning of input of the image signals DAT, a load signal LOAD for applying the relative data voltages to the data lines D₁-Dₘ, a reverse signal RVS for reversing the polarity of the data voltages with respect to the common voltage V_{com}, and a data clock signal HCLK.

Responsive to the data control signals CONT2 from the signal controller 600, the data driver 500 receives the image data DAT for a row of the pixels from the signal controller 600, converts the image data DAT into analog data voltages selected from the gray voltages supplied from the gray voltage generator 800, and then applies the data voltages to data lines D₁-Dₘ.

The gate driver 400 applies the gate-on voltage Von to the gate lines G₁-Gₙ in response to the gate control signals CONT1 from the signal controller 600, thereby turning on the switching elements Q connected thereto. The data voltages applied to the data lines D₁-Dₙ are supplied to the corresponding pixels through the activated switching elements Q.

The difference between the data voltage applied to the pixel and the common voltage V_{com} is represented as a voltage across the LC capacitor C_{LC}, namely, a pixel voltage. The LC molecules in the LC layer 3 have orientations that depend on the magnitude of the pixel voltage, and the orientations of the LC molecules determine the polarization of light passing through the LC layer 3. The polarizers (not shown), attached to the outer surfaces of the two panels 100 and 200, convert the light polarization into light transmittance.

By repeating this procedure by a unit of the horizontal period (which is denoted by “1H” and is equal to one period of the horizontal synchronizing signal H_{sync}, the data enable signal DE, and the gate clock CPV), all gate lines G₁-Gₙ are sequentially supplied with the gate-on voltage Vₒₙ during a frame, thereby applying the data voltages to all pixels. When the next frame starts after finishing one frame, the reverse control signal RVS applied to the data driver 500 is controlled such that the polarity of the data voltages is reversed with respect to that of the previous frame (which is referred to as “frame inversion”). The reverse control signal RVS may also be controlled such that the polarity of the data voltages flowing along a data line in one frame is reversed (for example, line inversion and dot inversion), or the polarity of the data voltages in one packet is reversed (for example, column inversion and dot inversion).

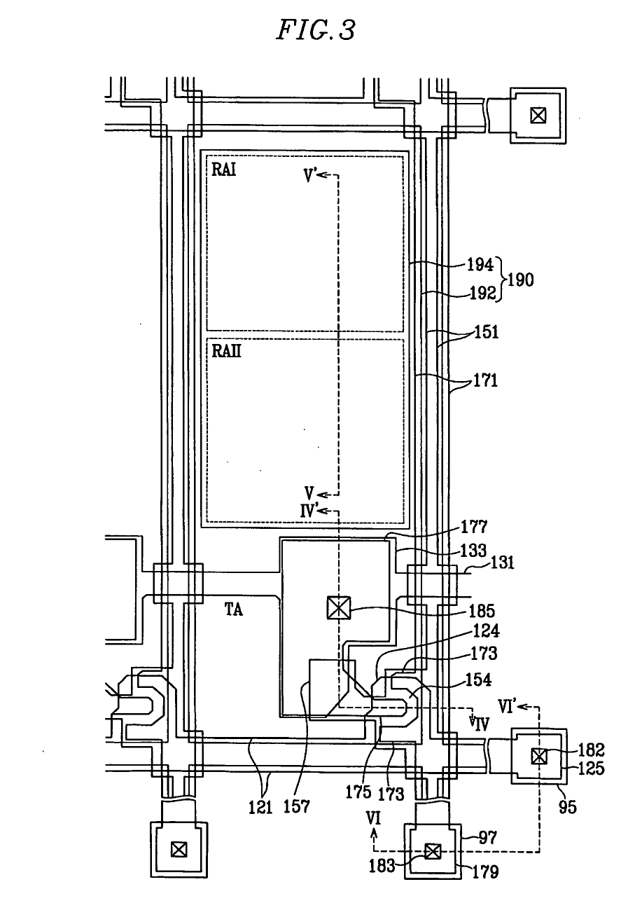

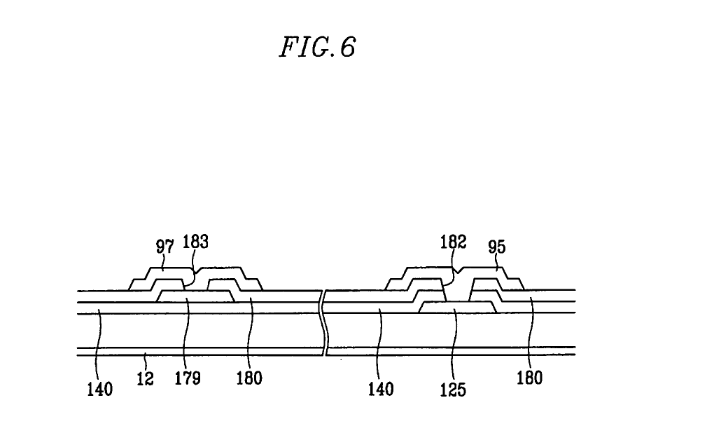

Hereinafter, the structure of the LCD according to an embodiment of the present invention will be described with reference to FIG. 3 through FIG. 6.

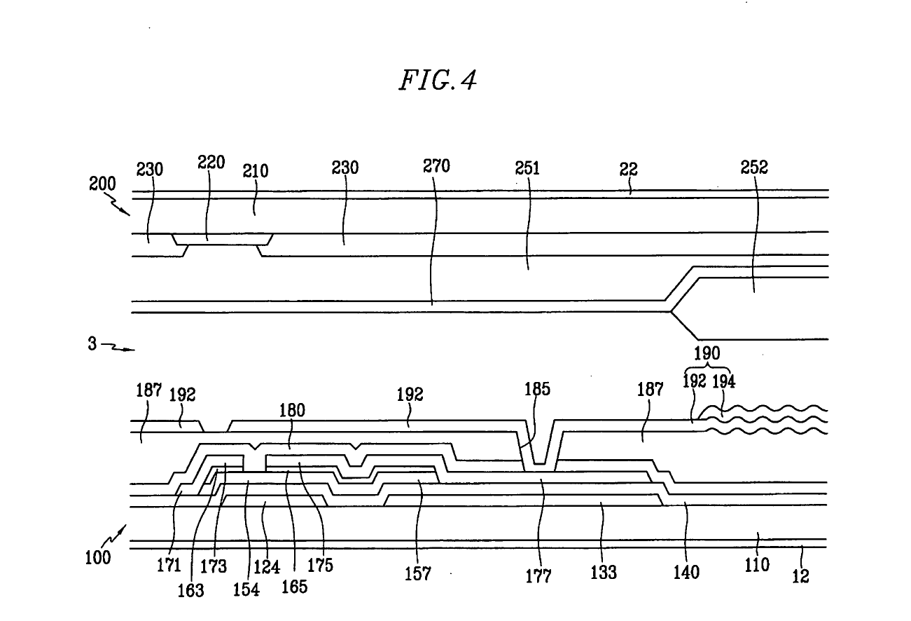

FIG. 3 is a layout view of an LCD according to an embodiment of the present invention, and FIG. 4 through FIG. 6 are cross-sectional views cut along IV-IV′, V-V′, and VI-VI′, of FIG. 3, respectively.

The LCD of this embodiment includes a TFT panel 100 and a common electrode panel 200 facing each other, with an LC layer 3 interposed therebetween. The LC layer 3 includes LC molecules aligned vertically or horizontally to the surfaces of the two panels 100 and 200.

As is known, the LC layer 3 may include 90° twisted nematic (TN) mode LC molecules, vertical alignment (VA) mode LC molecules, or electrically controlled birefringence (ECB) mode LC molecules, but it should be noted that the invention can be employed with any suitable LC composition.

Polarizers 12 and 22 are provided on the outer surfaces of the two panels 100 and 200. The transmission axis (θ) of the polarizer 22 is perpendicularly crossed with the transmission axis (θ+90°) of the polarizer 12.

TFT panel 100 as a lower panel of an LCD panel assembly 300 is configured as below.

As shown in FIG. 3 through FIG. 6, a plurality of gate lines 121 and a plurality of storage electrode lines 131 are formed on an insulating substrate 110 made of a transparent material such as glass.

The gate lines 121 extend substantially in a horizontal direction while being separated from each other, and transmit gate signals. Each gate line 121 includes a plurality of gate electrodes 124 protruding upward and an end portion 125 having a relatively large dimension to be connected to an external device.

The storage electrode lines 131 extend substantially in a horizontal direction and include a plurality of protrusions. These protrusions form storage electrodes 133. The storage electrode lines 131 receive a predetermined voltage such as a common voltage from a common electrode 270 of the common electrode panel 200.

The gate lines 121 and the storage electrode lines 131 may be made of an aluminum- (Al) containing metal such as Al and an Al alloy, a silver- (Ag) containing metal such as Ag and an Ag alloy, a copper- (Cu) containing metal such as Cu and a Cu alloy, a molybdenum- (Mo) containing metal such as Mo and a Mo alloy, chrome (Cr), titanium (Ti), or tantalum (Ta). The gate lines 121 and the storage electrode lines 131 may also have a double-layered structure in which two layers (not shown) having different physical properties are included. In such a structure, upper layers are made of a low resistivity metal, for example, an Al-containing metal such as Ag and an Ag alloy, in order to reduce delay of the signals or voltage drop in the gate lines 121 and the storage electrode lines 131. Differing from the upper layers, lower layers are made of a material having good contact properties with other materials, such as indium tin oxide (ITO), indium zinc oxide (IZO), etc. For example, Mo, a Mo alloy, Cr, Ta, Ti, etc., may be used for the lower layers. One desirable example of the combination of the two layers is a lower Cr layer and an upper Al—Nd layer.

The gate lines 121 and the storage electrode lines 131 may have a single-layered structure or a multi-layered structure including three or more layers.

All lateral sides of the gate lines 121 and the storage electrode lines 131 may slope in the range from about 30° to 80° to the surface of the substrate 110.

A gate insulating layer 140 made of silicon nitride (SiNx), etc., is formed on the gate lines 121.

A plurality of linear semiconductors 151 made of hydrogenated amorphous silicon, abbreviated as “a-Si”, or polysilicon are formed on the gate insulating layer 140. Each linear semiconductor 151 extends substantially in a vertical direction, and includes a plurality of projections 154 each extending along the gate electrode 124, and a plurality of extensions 157 each being connected to the respective projections 154. Also, each linear semiconductor 151 broadens in the immediate vicinities of places where the gate lines 121 are intersected with the storage electrode lines 131, in order to cover the intersected areas of the gate lines 121 and the storage electrode lines 131.

A plurality of linear ohmic contacts 161 and island-shaped ohmic contacts 165, which can be made of silicide or N+ hydrogenated amorphous silicon highly doped with N-type impurities, are formed on the linear semiconductors 151. Each linear ohmic contact 161 includes a plurality of projections 163. A set of the projection 163 and the island-shaped ohmic contact 165 are placed on the projection 154 of the semiconductor 151.

All lateral sides of the semiconductors 151 and the ohmic contacts 161 and 165 may slope in the range from about 30° to 80° to the surface of the substrate 110.

A plurality of data lines 171 and a plurality of drain electrodes 175 separated from the data lines 171 are formed on the ohmic contacts 161 and 165 and the gate insulating layer 140.

The data lines 171 extend substantially in a vertical direction to be crossed with the gate lines 121 and the storage electrode lines 131, and transmit data voltages. Each data line 171 includes an end portion 179 having a relatively large dimension to be connected to another layer or an external device.

Each drain electrode 175 includes an expansion 177 that is overlapped with the storage electrode 133 of the storage electrode line 131.

The vertical portion of each data line 171 includes a plurality of projections. The partial vertical portion including the two adjacent projections forms a source electrode 173, partially surrounding an edge of the drain electrode 175. A gate electrode 124, a source electrode 173, a drain electrode 175, and a projection 154 of a semiconductor 151 form a TFT. A TFT channel is formed in the projection 154 provided between the source electrode 173 and the drain electrode 175.

The data lines 171 and the drain electrodes 175 are preferably made of a refractory metal such as a Mo-containing metal, Cr, Ta, or Ti. The data lines 171 and the drain electrodes 175 may be configured to have the multi-layered structure including a lower layer (not shown) consisting of one among Mo, a Mo alloy, Cr, etc., and an upper layer (not shown) consisting of an Al-containing metal.

Similarly to the gate lines 121 and the storage electrodes 131, all of the lateral sides of the data lines 171 and the drain electrodes 175 may also slope in the range from about 30° to 80° to the surface of the substrate 110.

The ohmic contacts 161 and 165 are interposed between the semiconductor 151 and the data line 171, and between the drain electrode 175 and the projection 154 of the semiconductor 151, in order to reduce contact resistance therebetween. The linear semiconductors 151 are partially exposed at places where the data lines 171 and the drain electrodes 175 do not cover them, as well as between the source electrodes 173 and the drain electrodes 175.

A passivation layer 180, made of an inorganic material such as SiN₂, SiO₂, etc., is formed on the data lines 171, the drain electrodes 175, and the exposed portions of the semiconductors 151.

An organic insulating layer 187, made of a photosensitive organic material having a prominent planarization property, is formed on the passivation layer 180. A top surface of the organic insulating layer 187 is uneven. Due to the uneven surface, reflective electrodes 194 overlying the organic insulating layer 187 have uneven top surfaces. The uneven top surfaces of the reflective electrodes 194 help prevent mirror reflection, reducing undesired images shown on the LCD. The organic insulating layer 187 is removed from the end portions 125 and 179 of the gate lines 121 and the data lines 171, so only the passivation layer 180 remains on the end portions 125 and 179.

The passivation layer 180 is provided with a plurality of contact holes 183, through which the enlarged end portions 179 of the data lines 171 are exposed. A plurality of contact holes 182 penetrate the passivation layer 180 and the gate insulating layer 140 to expose the enlarged end portions 125 of the gate lines 121 therethrough. Also, a plurality of contact holes 185 penetrate the passivation layer 180 and the organic insulating layer 187 to expose the expansion areas 177 of the drain electrodes 175 therethrough. The contact holes 182, 183, and 185 may have various shapes such as polygonal, circular, etc., and the sidewalls of the contact holes 182, 183, and 185 may slope in the range from about 30° to 85° to the surface of the substrate 110, or are shaped as steps.

A plurality of pixel electrodes 190 are formed on the organic insulating layer 187.

Each pixel electrode 190 includes a transparent electrode 192 and a reflective electrode 194 overlying the transparent electrode 192. The transparent electrodes 192 can be made of a transparent conductive material such as ITO or IZO, and the reflective electrodes 194 can be made of a reflective opaque material such as Al, an Al alloy, Ag, or an Ag alloy. Each pixel electrode 190 may further include a contact assistant (not shown) made of Mo, a Mo alloy, Cr, Ti, or Ta. The contact assistants ensure contact properties between the transparent electrodes 192 and the reflective electrodes 194, while preventing the transparent electrodes 192 from oxidizing the reflective electrodes 194.

Each pixel is divided into a transmissive area TA and a reflective area RA consisting of a first reflective area RAI and a second reflective area RAII. The transmissive area TA is an area without the reflective electrode 194, while the first and second reflective areas RAI and RAII are areas with the reflective electrode 194. The cell gap of the transmissive area TA is nearly equal to that of the reflective area RA. Here, the organic insulating layer 187 may be removed from the transmissive area TA.

The pixel electrodes 190 are physically and electrically connected to the drain electrodes 175 through the contact holes 185 to receive data voltages from the drain electrodes 175. The pixel electrodes 190 supplied with the data voltages generate electric fields in cooperation with the common electrode 270, determining the orientations of LC molecules in the LC layer 3 interposed between the two electrodes.

Also, each liquid crystal capacitor capable of storing the applied voltage after the TFT is turned off is formed of a set of the pixel electrodes 190 and the common electrode 270, as previously mentioned. To enhance the voltage storage ability, storage capacitors, connected to the liquid crystal capacitors in parallel, are further provided. The storage capacitors are implemented by overlapping the expansions 177 of the drain electrodes 175 with the storage electrode lines 131. The storage capacitors may also be implemented by overlapping the pixel electrodes 190 with the gate lines 121 adjacent thereto. In this case, the storage electrode lines 131 may be omitted.

The pixel electrodes 190 may be overlapped with the data lines 171 adjacent thereto as well as the gate lines 121 adjacent thereto, in order to increase the aperture ratio, but such overlap portions are not necessary to the invention.

The pixel electrodes 190 may be made of a transparent conductive polymer. However, in reflective LCDs, opaque reflective metals can be used.

A plurality of contact assistants 95 and 97 overlying the passivation layer 180 of the pad portion are individually connected to the end portions 125 of the gate lines 121 and the end portions 179 of the data lines 171 through the contact holes 182 and 183. The contact assistants 95 and 97 are to supplement adhesion between the end portions 125 and 179 and exterior devices, and to protect them. However, they may be omitted at any case because they are not essential. Also, they may be formed on the same layer as the transparent electrodes 192 or the reflective electrodes 194.

The common electrode panel 200 facing the TFT panel 100 is configured as below.

A shading means 220 called a “black matrix” can be provided on an insulating substrate 210 made of a transparent insulating material such as glass, to prevent light from leaking out through barriers between the pixel electrodes 190 and to define aperture regions facing the pixel electrodes 190.

A plurality of color filters 230 are formed on the substrate 210 and the shading means 220, and most of them are placed within the aperture regions defined by the shading means 220. Each color filter 230 is placed between the two adjacent data lines 171 in a vertical direction. Each color filter 230 may exhibit one primary color such as red, green, and blue. The color filters 230 are connected to one another in the form of stripes.

Overcoat layers 251, 252, and 253, and a common electrode 270, which are made of transparent insulating materials, are alternately formed on the color filters 230. In detail, in the transmissive area TA and the first reflective area RAI, the common electrode 270 is formed on the overcoat layers 251 and 253 overlying the color filters 230, while in the second reflective area RAII, the common electrode 270 is formed on the color filters 230, and the overcoat layer 252 is formed thereon.

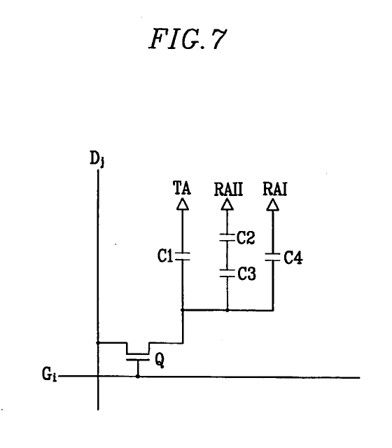

In the second reflective area RAII formed in this manner, two layers having different permittivities are overlapped between the common electrode 270 and the pixel electrodes 190, thereby forming two capacitors C2 and C3 connected in series as shown in FIG. 7. The capacitor C3 is an LC capacitor formed within the LC layer 3. The capacitor C2 is an auxiliary capacitor formed within the overcoat layer 253. In the second reflective area RAII, a voltage applied to the LC capacitor C3 is smaller than that of the first reflective area RAI due to the auxiliary capacitor C2.

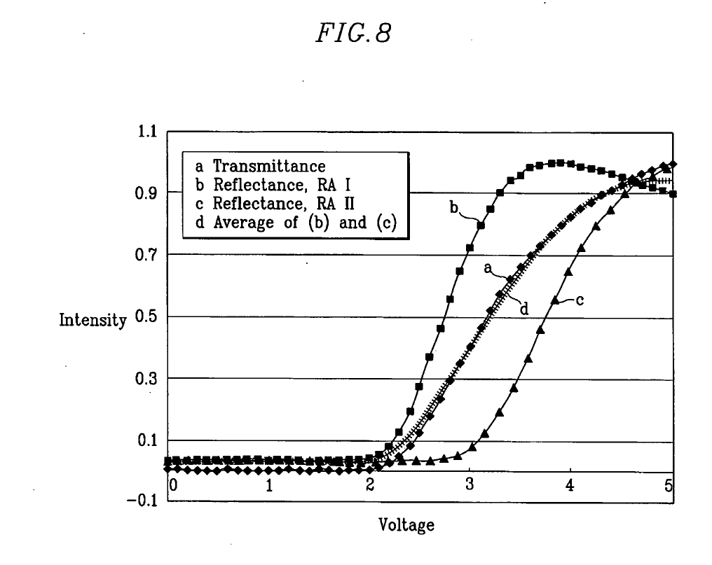

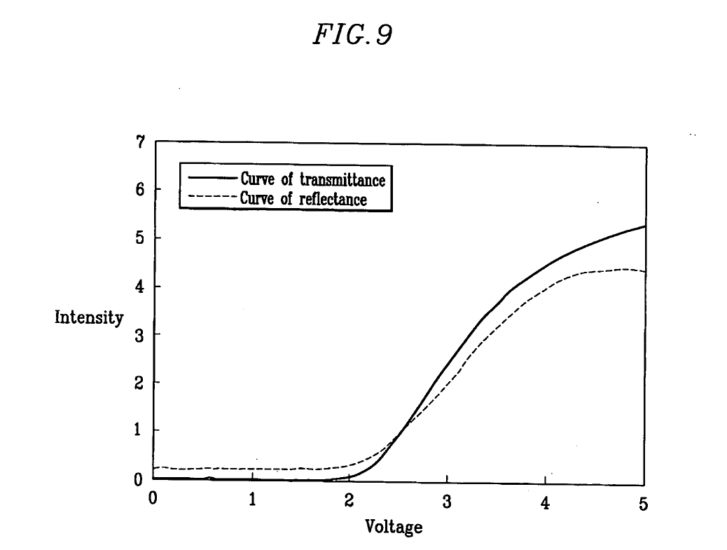

Hereinafter, a method of a gamma curve of the reflective mode and a gamma curve of the transmissive mode will be described in detail with reference with FIG. 8 through FIG. 9.

FIG. 8 is a graph showing simulation results for transmittance and reflectance of an LCD according to an embodiment of the present invention, and FIG. 9 is a graph showing actually measured transmittance and reflectance from an LCD according to an embodiment of the present invention.

In the graphs of FIG. 8 and FIG. 9, horizontal axes represent “voltage”, and vertical axes represent “intensity” (i.e., luminance).

Referring to FIG. 8, (a) is a curve of transmittance for the transmissive area TA, (b) and (c) are curves of reflectance for the first and second reflective areas RAI and RAII, respectively, and (d) is an average curve of the two curves (b) and (c). In the graphs, the curves (a), (b), and (c) reflect actually measured results, while the curve (d) reflects simulated results.

The total reflectance Rt of the first and second reflective areas RAI and RAII is obtained by adding the reflectance R1 of the first reflective area RAI and the reflectance R2 of the second reflective area RAII. Each of R1 and R2 is obtained by multiplying dimension (1−s) (area ratio of the first reflective area with respect to total reflective area) or s (area ratio of the second reflective area with respect to total reflective area) and the voltage of the corresponding area. These relations can be represented by the equation:

$$\begin{matrix}Rt = R 1 + R 2 \\ = ( 1 - s ) V + skV\end{matrix}$$

where V is the magnitude of a pixel voltage, s is the dimension ratio obtained by A2/(A1+A2), k is the dividing ratio of voltage obtained by C2/(C2+C3), and kV is a voltage across the LC capacitor C3 of the second reflective area RAII.

An optimum condition for matching the curve (d) reflecting the total reflectance to the curve (a) reflecting the transmittance may be obtained by varying the dimension ratio s and the dividing ratio of voltage k, based on the above-mentioned equation. FIG. 8 shows the results when s is 0.6 and k is 0.82.

FIG. 9 shows actually measured transmittance and reflectance from the LCD based on the above-mentioned simulations. As shown in this figure, the two curves become somewhat distant near 5V, but threshold voltages Vth are nearly equal near 2V.

These results predict that controlling the dimension ratio s and the dividing ratio of voltage k makes it possible to match the two gamma curves of the transmissive and reflective modes.

In this case, if the dimension ratio s for the first reactive area RAI and the second reflective area RAII is in the range from 0.3:0.7 to 0.5:0.5 and the voltage ratio k between voltages across the LC capacitors C1 and C3 is in the range from 1:0.6 to 1:0.9, the threshold voltages Vth of the two areas can have nearly equal values. As a result, the gamma curves of the two modes can be made to nearly coincide.

Meanwhile, the thickness of the overcoat layer 252 forming the auxiliary capacitor C2 can be determined using the dividing ratio of voltage k.

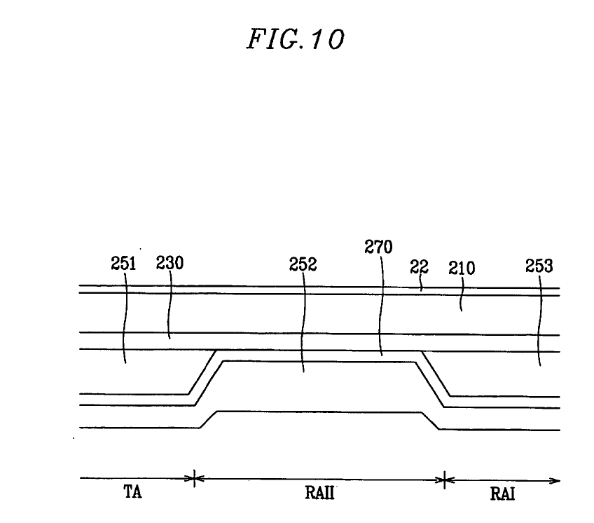

FIG. 10 is a schematic cross-sectional view of a pixel employed in an LCD according to an embodiment of the present invention.

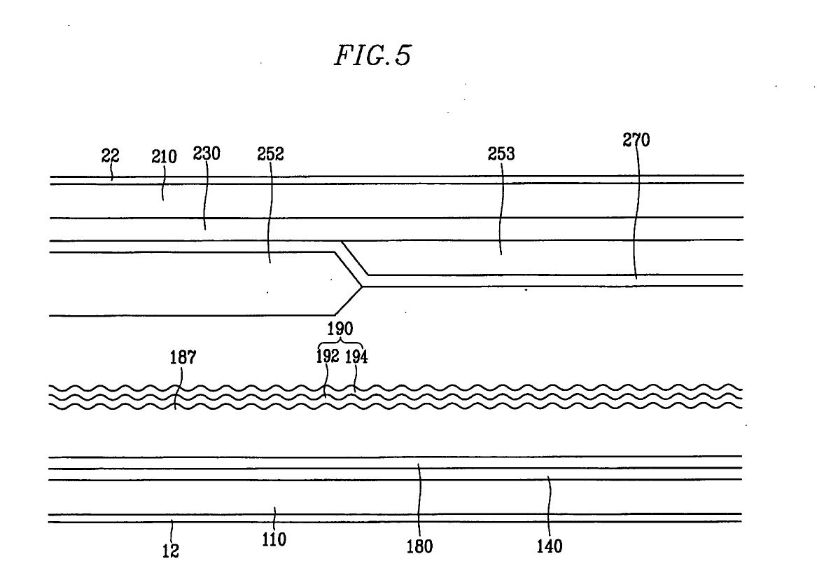

In FIG. 4 and FIG. 5, the overcoat layers 251, 252, and 253 are alternately arranged with the common electrode 270. In particular, the overcoat layer 252 is formed only on the common electrode 270 corresponding to the second reflective area RAII. Differing from FIG. 4 and FIG. 5, the overcoat layer 252 of FIG. 10 is formed over the common electrode 270 corresponding to all areas TA, RAI, and RAII.

In the case of the pixel shown in FIG. 10, the voltage across the LC capacitor C1 and capacitor C4 in the transmissive area TA and first reflective area RAI may decrease due to the capacitors of the overcoat layer 252, but this pixel structure is advantageous in that a mask is less required in the manufacturing process compared with the pixel structure shown in FIG. 4 and FIG. 5.

In more detail, in the case of the pixel shown in FIG. 4 and FIG. 5, after an overcoat layer is formed, the second reflective area RAII is patterned with a photo-etching process using a mask. A common electrode 270 is then formed, and another overcoat layer 252 is formed thereon. Then, a patterning process using another mask is performed so that the overcoat layer 252 exists only in the second reflective area RAII. Differing from such a structure, in the pixel structure shown in FIG. 10, the patterning process using the mask, which is performed after the overcoat layer 252 is formed, is omitted. Accordingly, a mask is eliminated.

In the embodiment shown in FIG. 10, the thickness of the overcoat layers 251, 252, and 253 may also be individually controlled using the dividing ratio of voltage k.

According to the present invention, the reflective area is divided into two areas and an auxiliary capacitor is provided in one area of the two. The gamma curves for the transmissive mode and the reflective mode can be matched over a particular range by controlling the dimension ratio and the voltage ratio of the two areas. In this way, color displays showing uniform color can be realized without regard to changes in mode.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A liquid crystal display comprising:
a plurality of pixels arranged in a matrix, each including a switching element;
a backlight for supplying light to the pixels; and
first, second, third, and fourth capacitors which are individually connected to output terminals of the switching elements;
wherein each of the pixels includes a first area for transmitting light supplied by the backlight, and a second area and a third area for reflecting light.

2. The liquid crystal display of claim 1, wherein the first capacitor is located within the first area, the second capacitor is located within the second area, and the third and fourth capacitors are located within the third area.

3. The liquid crystal display of claim 2, wherein the third and fourth capacitors have differing permittivities and are connected to each other in series.

4. The liquid crystal display of claim 3, wherein a voltage applied to the second capacitor is equal to sum of a voltage applied to the third capacitor and a voltage applied to the fourth capacitor.

5. The liquid crystal display of claim 4, satisfying:
Rt=R2+R3=(1−s)V+skV
where Rt is a total reflectance of the second area and the third area, R2 is a reflectance of the second area, R3 is a reflectance of the third area, s is a dimension ratio of an area of the third area to the total area of the second area and the third area, V is a voltage applied to the second capacitor, and k is a voltage ratio of a voltage applied to the third capacitor with respect to a sum of a voltage applied to the third capacitor and a voltage applied to the fourth capacitor.

6. The liquid crystal display of claim 5, wherein the voltage ratio k is determined according to:
k=C4/(C3+C4)
where C3 is a capacitance of the third capacitor, and C4 is a capacitance of the fourth capacitor.

7. The liquid crystal display of claim 6, wherein a voltage ratio of a voltage applied to the second capacitor to a voltage applied to the third capacitor is in a range from about 1:0.6 to about 1:0.9.

8. The liquid crystal display of claim 7, wherein a dimension ratio of an area of the second area to an area of the third area is in a range from about 0.3:0.7 to about 0.5:0.5.

9. A liquid crystal display comprising
an upper panel and a lower panel facing each other, and
a liquid crystal layer interposed between the two panels,
wherein the upper panel comprises:
an insulating substrate;
a shading means formed on the insulating substrate;
a plurality of color filters formed on the shading means and the insulating substrate;
a first overcoat layer and a second overcoat layer formed on the color filters;
a common electrode formed on the first and second overcoat layer and the color filters; and
a third overcoat layer formed on the common electrode.

10. The liquid crystal display of claim 9, wherein the upper panel includes a first area for transmitting light within the liquid crystal display, and a second area and a third area for reflecting light outside the liquid crystal display.

11. The liquid crystal display of claim 10, wherein the first overcoat layer and the second overcoat layer are respectively formed to correspond to the first area and the second area, and the third overcoat layer is formed to correspond to the third area.

12. The liquid crystal display of claim 10, wherein the first overcoat layer and the second overcoat layer are respectively formed to correspond to the first area and the second area, and the third overcoat layer is formed throughout the first, second, and third areas.

13. The liquid crystal display of claim 11 or claim 12, wherein the lower panel includes pixel electrodes to which data voltages are applied; and
wherein the pixel electrodes respectively include a transparent electrode formed throughout the first, second, and third areas, and a reflective electrode formed on the second and third areas.

14. The liquid crystal display of claim 13, wherein the first and second areas include a first and second capacitors, respectively, each capacitor includes the pixel electrode and the common electrode as two terminals and the liquid crystal layer as a dielectric; and
wherein the third area includes a third capacitor having the liquid crystal layer as a dielectric and a fourth capacitor having the third overcoat layer as a dielectric, and the third capacitor and the fourth capacitor are connected in series between the pixel electrode and the common electrode.

15. The liquid crystal display of claim 14, satisfying the equation:
Rt=R2+R3=(1−s)V+skV
where Rt is a total reflectance of the second and third areas, R2 is a reflectance of the second area, R3 is a reflectance of the third area, s is a dimension ratio of an area of the third area to a total area of the second area and third area, V is a voltage applied to the second capacitor, and k is a voltage ratio of a voltage applied to the third capacitor to a sum of the voltage applied to the third capacitor and the voltage applied to the fourth capacitor.

16. The liquid crystal display of claim 15, wherein the voltage ratio k is determined by:
k=C4/(C3+C4)
where C3 is a capacitance of the third capacitor, and C4 is a capacitance of the fourth capacitor.

17. The liquid crystal display of claim 16, wherein the voltage ratio k is in a range from about 0.6 to about 0.9.

18. The liquid crystal display of claim 17, wherein the dimension ratio s is in a range from about 1 to about 2⅓.

19. The liquid crystal display of claim 18, wherein the first, second, and third overcoat layers comprise transparent insulating materials.

20. The liquid crystal display of claim 19, wherein the pixel electrode formed in the second and third areas includes an uneven pattern.

21. The liquid crystal display of claim 20, wherein the liquid crystal display is configured to operate in a transmissive mode and in a reflective mode, and wherein a threshold voltage of the liquid crystal layer in the transmissive mode is substantially equal to a threshold voltage of the liquid crystal layer in the reflective mode.
